(19) United States
(12) Patent Application Publication
(10) Pub. No.: US 2011/0267560 A1
(43) Pub. Date: Nov. 3, 2011

(54) LIQUID CRYSTAL DISPLAY APPARATUS AND BACKLIGHT

(75) Inventor: Naru Usukura, Osaka-shi (JP)

(73) Assignee: SHARP KABUSHIKI KAISHA, Osaka-shi, Osaka (JP)

(21) Appl. No.: 13/143,214

(22) PCT Filed: Dec. 10, 2009
(86) PCT No.: PCT/JP2009/006747

§ 371 Date: Jul. 5, 2011

(30) Foreign Application Priority Data
Jan. 9, 2009 (JP) 2009-004092

(51) Int. Cl. G02F 1/13357; G02F 1/1335

(52) U.S. Cl. 349/62; 362/97.2

(57) ABSTRACT

The present invention provides display with high light utilization efficiency, with increased luminance being provided in desired directions.

A liquid crystal display device of the present invention has a plurality of pixels arranged in a matrix along a first direction and a second direction which are perpendicular to each other, and includes: a TFT substrate; a counter substrate; a liquid crystal layer interposed between the TFT substrate and the counter substrate; an optical film including a polarizer provided on a surface of the TFT substrate which is opposite to the liquid crystal layer; and a backlight provided on a side of the optical film which is opposite to the TFT substrate, wherein the backlight includes an optical element layer provided on a side of the light guide plate which is closer to the optical film, and the optical element layer includes a plurality of lenticular lenses extending in the first direction, each of the lenticular lenses having a light receiving surface protruding toward the light guide plate.

### TECHNICAL FIELD

The present invention relates to a backlight and a liquid crystal display device which performs display using a backlight.

### BACKGROUND ART

In recent years, liquid crystal display devices are widely used as display devices for monitors, projectors, mobile information terminals, mobile phones, and the like. Generally speaking, a liquid crystal display device allows the transmittance (or reflectance) of a liquid crystal panel to vary with a driving signal, thus modulating the intensity of light from a light source for irradiating the liquid crystal panel, whereby images and text characters are displayed. Liquid crystal display devices include direct-viewing type display devices in which images or the like that are displayed on the liquid crystal panel are directly viewed, projection-type display devices (projectors) in which displayed images are projected onto a screen through a projection lens in an enlarged size, and so on.

By applying a driving voltage which corresponds to an image signal to each of the pixels that are in a regular matrix arrangement, a liquid crystal display device causes a change in the optical characteristics of a liquid crystal layer in each pixel, and regulates the transmitted light in accordance with the optical characteristics of the liquid crystal layer with polarizers (which typically are polarizing plates) being disposed at the front and rear thereof, thereby displaying images, text characters, and the like. In the case of a direct-viewing type liquid crystal display device, usually, these polarizing plates are directly attached to a light-entering substrate (the rear substrate) and a light-outgoing substrate (the front substrate or viewer-side substrate) of the liquid crystal panel.

Examples of the direct-viewing type liquid crystal display device include reflective liquid crystal display devices which perform display by means of reflection by a reflection layer of light incoming at the front substrate of the liquid crystal display panel and transmissive liquid crystal display devices which perform display by means of transmission through the liquid crystal layer of light incoming at the rear substrate from the backlight. An example of the transmissive liquid crystal display devices is described in Patent Document 1.

The liquid crystal display device of Patent Document 1 includes, in order to increase the vertical viewing angle of the TN-type liquid crystal display device, a light control sheet that is provided over a surface of the backlight which is closer to the liquid crystal panel and a viewing angle adjustment sheet that is provided over a substrate at a light-emitting side of the liquid crystal panel. The light control sheet has a row of recessed and raised portions which are arranged along one direction. The viewing angle adjustment sheet has a plurality of lens portions which are arranged along the same direction as the row of recessed and raised portions of the light control sheet. Incoming light to the liquid crystal panel is condensed by the light control sheet to have increased front luminance, while outgoing light is only vertically dispersed by the viewing angle adjustment sheet. This enables providing display with only vertically increased vertical angles.

Patent Document 2 describes a surface-emission light source element which is provided at the light-emitting side of the backlight for the purpose of adjusting the viewing angle characteristics. This surface-emission light source element includes a first prism sheet which is composed of a plurality of prisms extending in a predetermined direction and a second prism sheet which is composed of a plurality of prisms extending in a direction that is different from the predetermined direction. The vertex angle of each prism of the first prism sheet is 50° to 75°. The vertex angle of each prism of the second prism sheet is 110° to 150°. This arrangement enables providing a surface-emission light source which provides high luminance in a direction normal to the substrate surface and which provides a wide viewing angle range.

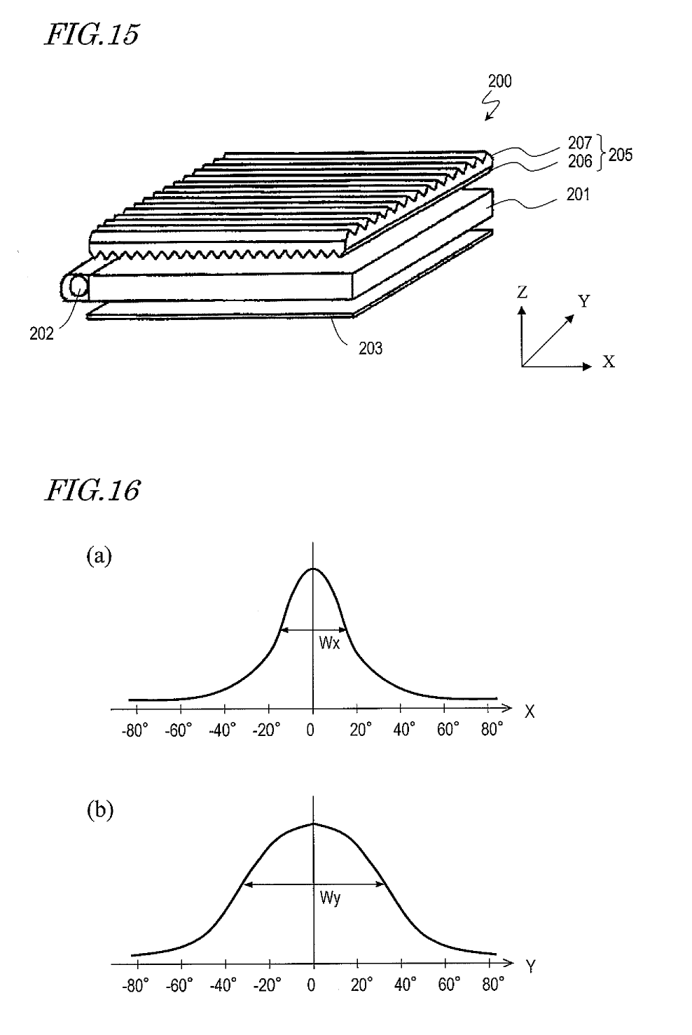

Patent Document 3 describes a liquid crystal display for use in, for example, a monitor display section of a vehicle navigation device. FIG. 14 is a diagram used in Patent Document 3 for illustrating the problems in an onboard liquid crystal display device.

As illustrated with the use of FIG. 14, a conventional liquid crystal display 4 which is for use in a vehicle navigation device or the like emits display light not only toward a driver 1 and the passenger seat but also in other wide azimuth angle directions and polar angle directions with generally equal intensities. As a result, in FIG. 14, reflected images 4A and 4B of the display occur in the windshield 5 or the door glass 6, which may disadvantageously impede the driving operation of the driver 1.

As a solution to such a problem, Patent Document 3 describes the technique of modifying the direction of light emitted from the backlight by means of an emission-direction modifying element that is composed of a row of prisms such that light emitted from the display section of the liquid crystal display has directivity, so that bright display is provided only in a specific direction.

### CITATION LIST

### Patent Literature

Patent Document 1: Japanese Laid-Open Patent Publication No. 9-50029

Patent Document 2: Japanese Laid-Open Patent Publication No. 2000-56106

Patent Document 3: Japanese Laid-Open Patent Publication No. 7-306411

### SUMMARY OF INVENTION

### Technical Problem

FIG. 15 is a perspective view showing the configuration of a backlight 200 which is the same as that disclosed in Patent Document 2. As illustrated in FIG. 15, the backlight 200 includes a light guide plate 201, a light source 202 provided on one side surface of the light guide plate 201, a reflector 203 provided under the light guide plate 201, and a prism sheet 205 provided above the light guide plate 201. The prism sheet 205 includes a first prism sheet 206 which has a plurality of prisms that are downwardly tapered and a second prism sheet 207 which has a plurality of prisms that are upwardly tapered. Each of the prisms of the first prism sheet 206 is extending in the Y direction in a horizontal plane (a plane including the upper or lower surface of the light guide plate). Each of the prisms of the second prism sheet 207 is extending in the X direction in a horizontal plane, the X direction being perpendicular to the Y direction.

FIG. 16 shows an example of the viewing angle characteristic (the polar angle dependence of the luminance) achieved by the backlight 200. FIG. 16(a) shows the viewing angle characteristic in the X direction. FIG. 16(b) shows the viewing angle characteristic in the Y direction. Here, the “polar angle” refers to an angle which is defined on the assumption that the direction vertical to the surface (the Z direction that is vertical to a horizontal plane) is 0° and the direction along the horizontal plane is −90° or 90°.

In the backlight which has the configuration such as shown in FIG. 15, light which exceeds the critical angle is emitted from the light guide plate 201, so that the directivity in the X direction is increased. The first prism sheet 206 has the function of controlling the viewing angle mainly in the X direction by deflecting the light emitted from the light guide plate 201 so as to travel in the direction vertical to the surface. The vertex angle of each prism of the first prism sheet 206 is preferably around 60°. By adjusting the vertex angle, the half-value width (Full width of polar angle at half maximum) of the viewing angle characteristic in the X direction, Wx, can be adjusted within the range of ±5 to 20°. The second prism sheet 207 has the function of mainly controlling the viewing angle in the Y direction for light emitted from the light guide plate 201. When the vertex angle of each prism of the second prism sheet 207 is, for example, 120°, the effect of narrowing the half-value width Wy of the viewing angle characteristic in the Y direction by around 10° is achieved, as compared to a configuration which does not include the second prism sheet 207. With such an arrangement, the directivity of the luminance when viewed along the X direction is greater than the directivity of the luminance when viewed along the Y direction. For either of the X and Y directions, the direction of the directivity is generally identical with the direction of polar angle 0°.

In this specification, light “having directivity” means that emitted light has a greater intensity in a specific direction. The degree of directivity, i.e., how high the directivity in the specific direction is, is represented by the half-value width of angle in the intensity distribution of the emitted light. The direction indicated by the midpoint of the half-value width of angle is defined as “direction of directivity”.

As described above, the backlight 200 can make the viewing angle characteristics for the X direction and the Y direction different. However, the backlight 200 having such characteristics is not suitable to an onboard liquid crystal display device. In other words, reflection of images such as illustrated in FIG. 14 can be prevented by adjusting the viewing angle characteristics by means of the prism sheet 205 of the backlight 200, although, in that case, however, display provided by the liquid crystal display device has such directivity that the luminance is high in the direction of polar angle 0°.

Therefore, as shown in FIG. 14, when the backlight 200 is provided between the driver's seat and the passenger seat where a traverse direction from the driver's seat to the passenger seat is the X direction, display provided by the backlight 200 exhibits strong directivity in the Z direction that is perpendicular to X, at a midpoint between the driver's seat and the passenger seat, while display with relatively low luminance can only be provided to the driver and the passenger in the passenger's seat. When the luminance in a direction toward the driver, for example, is increased by adjusting the vertex angle of the respective prisms of the prism sheet 205 with the view of solving this problem, the luminance for the central azimuth is further increased so that the light utilization efficiency decreases, while light leaks toward the side mirror to cause reflection of images.

The present invention was conceived in view of the above problems. One of the objects of the present invention is to provide display with high light utilization efficiency, in which the luminance in desired directions is increased while the luminance in undesired directions is decreased. Another object of the present invention is to provide an onboard liquid crystal display device which is suitably used in vehicles, airplanes, ships, etc., or a light source.

### Solution to Problem

According to the first aspect of the present invention, there is provided a liquid crystal display device having a plurality of pixels arranged in a matrix along a first direction and a second direction which are perpendicular to each other, including: a TFT substrate including a plurality of pixel electrodes arranged so as to correspond to the plurality of pixels; a counter substrate including a counter electrode which opposes to the pixel electrodes; a liquid crystal layer interposed between the TFT substrate and the counter substrate; an optical film including a polarizer provided on a surface of the TFT substrate which is opposite to the liquid crystal layer; and a backlight provided on a side of the optical film which is opposite to the TFT substrate, wherein the backlight includes a light guide plate for guiding light emitted from a light source and an optical element layer provided on a side of the light guide plate which is closer to the optical film, and the optical element layer includes a plurality of lenticular lenses extending in the first direction, each of the lenticular lenses having a light receiving surface protruding toward the light guide plate.

According to the second aspect of the present invention which is based on the first aspect, the backlight includes a prism sheet interposed between the light guide plate and the optical element layer, and the prism sheet includes a plurality of prisms extending in the second direction, each of the prisms having a vertex portion tapered toward the light guide plate.

According to the third aspect of the present invention which is based on the first or second aspect, the light receiving surface of each of the plurality of lenticular lenses includes a first curve surface protruding toward the backlight and a second curve surface and a third curve surface between which the first curve surface extends, and if a curvature of the first curve surface is a positive curvature, each of the second and third curve surfaces has a negative curvature.

According to the fourth aspect of the present invention which is based on the third aspect, the light receiving surface does not include a flat surface but is composed of the first curve surface, the second curve surface and the third curve surface.

According to the fifth aspect of the present invention which is based on the third or fourth aspect, the second curve surface and the third curve surface have substantially equal curvatures.

According to the sixth aspect of the present invention which is based on the fifth aspect, the ratio of an absolute value of each of the curvature of the second curve surface and the curvature of the third curve surface to an absolute value of the curvature of the first curve surface is not less than 50% and not more than 150%.

According to the seventh aspect of the present invention which is based on any of the third to sixth aspects, a cross section of the first curve surface in a plane which is perpendicular to the TFT substrate and which includes the second direction is a circumference portion of an osculating circle of the curvature of the first curve surface which corresponds to a central angle of not less than 100° and not more than 140°, and a cross section of the second curve surface and a cross section of the third curve surface in a plane which is perpendicular to the TFT substrate and which includes the second direction are circumference portions of osculating circles of the curvature of the second curve surface and the curvature of the third curve surface which correspond to a central angle of not less than 10° and not more than 25°.

According to the eighth aspect of the present invention which is based on any of the first to seventh aspects, the liquid crystal display device further includes a microlens array between the TFT substrate and the optical film, the microlens array having a plurality of microlenses extending in the second direction.

According to the ninth aspect of the present invention which is based on any of the first to eighth aspects, there is provided an onboard liquid crystal display device.

According to the tenth aspect of the present invention, there is provided a backlight for supplying light for display to a liquid crystal display device, including: a light guide plate for guiding light emitted from a light source; and an optical element layer provided over a light emitting surface of the light guide plate, wherein the optical element layer includes a plurality of lenticular lenses extending in a first direction, each of the lenticular lenses having a light receiving surface protruding toward the light guide plate.

According to the eleventh aspect of the present invention which is based on the tenth aspect, the backlight further includes a prism sheet interposed between the light guide plate and the optical element layer, the prism sheet including a plurality of prisms extending in a second direction that is perpendicular to the first direction, each of the prisms having a vertex portion tapered toward the light guide plate.

According to the twelfth aspect of the present invention which is based on the eleventh aspect, the light receiving surface of each of the plurality of lenticular lenses includes a first curve surface protruding toward the light guide plate and a second curve surface and a third curve surface between which the first curve surface extends, and if a curvature of the first curve surface is a positive curvature, each of the second and third curve surfaces has a negative curvature.

According to the thirteenth aspect of the present invention which is based on the twelfth aspect, the light receiving surface does not include a flat surface but is composed of the first curve surface, the second curve surface and the third curve surface.

According to the fourteenth aspect of the present invention which is based on the twelfth or thirteenth aspect, the second curve surface and the third curve surface have substantially equal curvatures.

According to the fifteenth aspect of the present invention which is based on the fourteenth aspect, the ratio of an absolute value of each of the curvature of the second curve surface and the curvature of the third curve surface to an absolute value of the curvature of the first curve surface is not less than 50% and not more than 150%.

According to the sixteenth aspect of the present invention which is based on any of the twelfth to fifteenth aspects, a cross section of the first curve surface in a plane which is perpendicular to the light emitting surface of the light guide plate and which includes the second direction is a circumference portion of an osculating circle of the curvature of the first curve surface which corresponds to a central angle of not less than 100° and not more than 140°, and a cross section of the second curve surface and a cross section of the third curve surface in a plane which is perpendicular to the light emitting surface and which includes the second direction are circumference portions of osculating circles of the curvature of the second curve surface and the curvature of the third curve surface which correspond to a central angle of not less than 10° and not more than 25°.

### Advantageous Effects of Invention

A liquid crystal display device of the present invention can provide display in such a manner that the luminance is relatively uniform and high in specific directions while the luminance is extremely low in the other directions, so that light utilization efficiency improves. In the liquid crystal display device of the present invention, the intermediate luminance region ranging between the region in which high luminance display is provided and the region in which low luminance display is provided can be narrowed. Therefore, display with high light utilization efficiency can be provided such that display light is concentrated in a desired range. When a liquid crystal display device of the present invention is installed in a vehicle, high quality display can be provided to passengers, while reflection of images in the side door's glass, and the like, can be reduced.

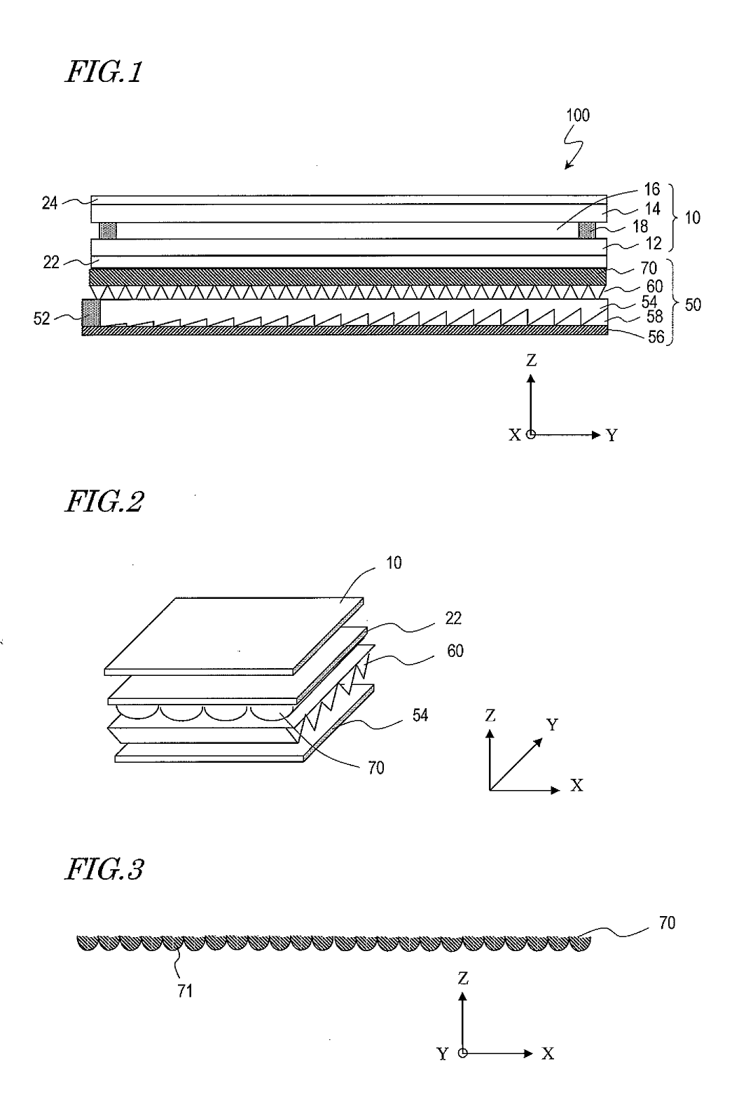

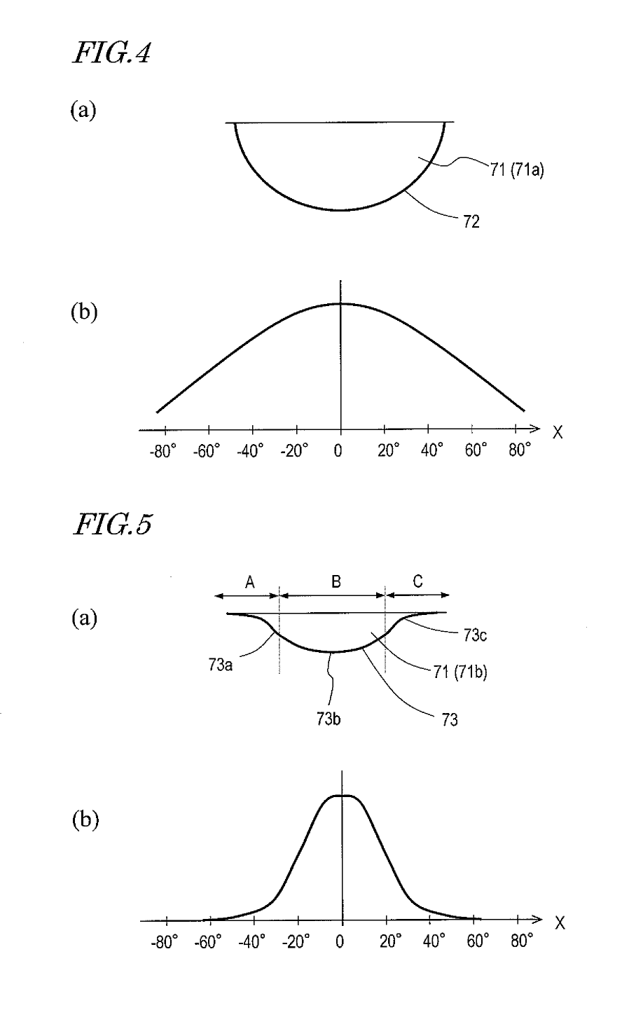

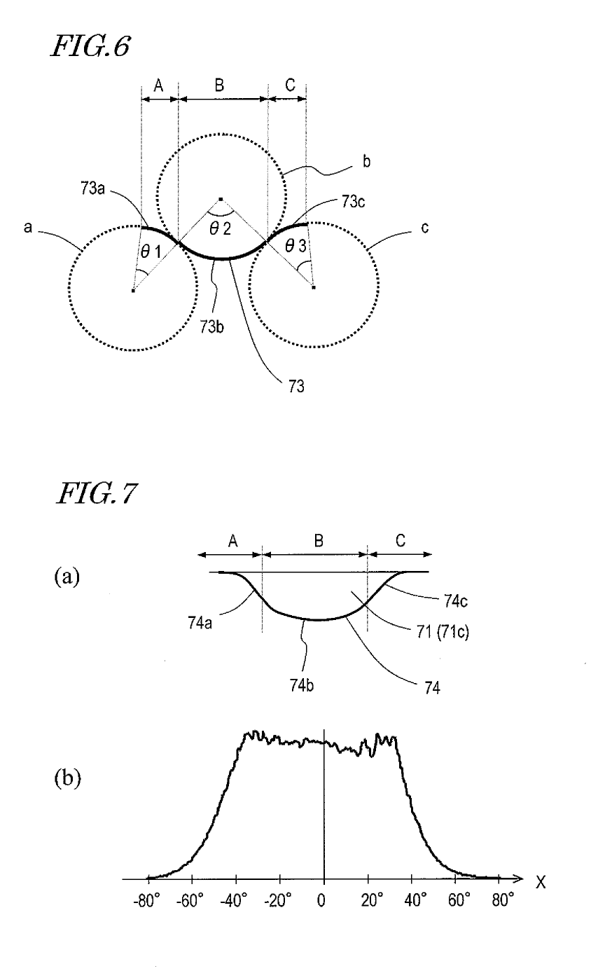

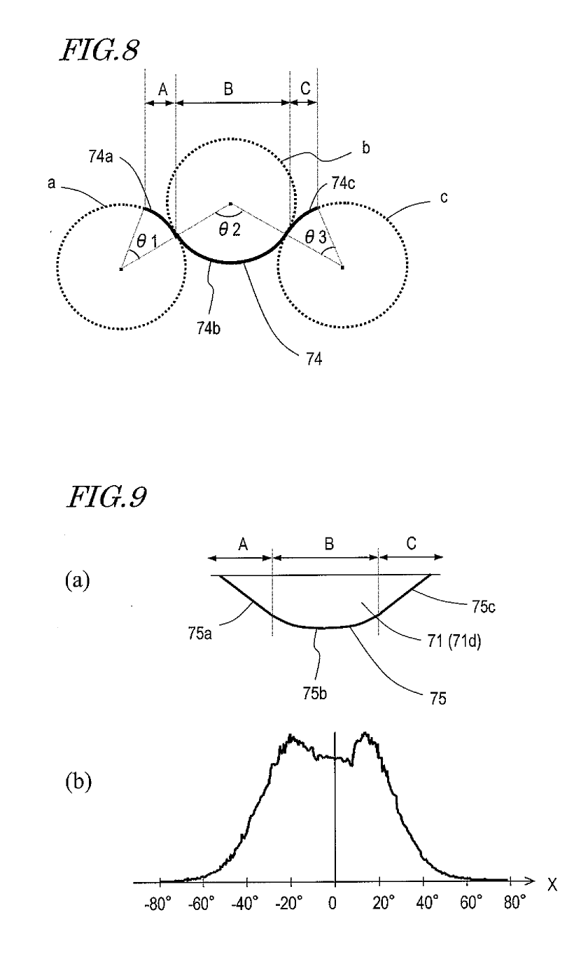

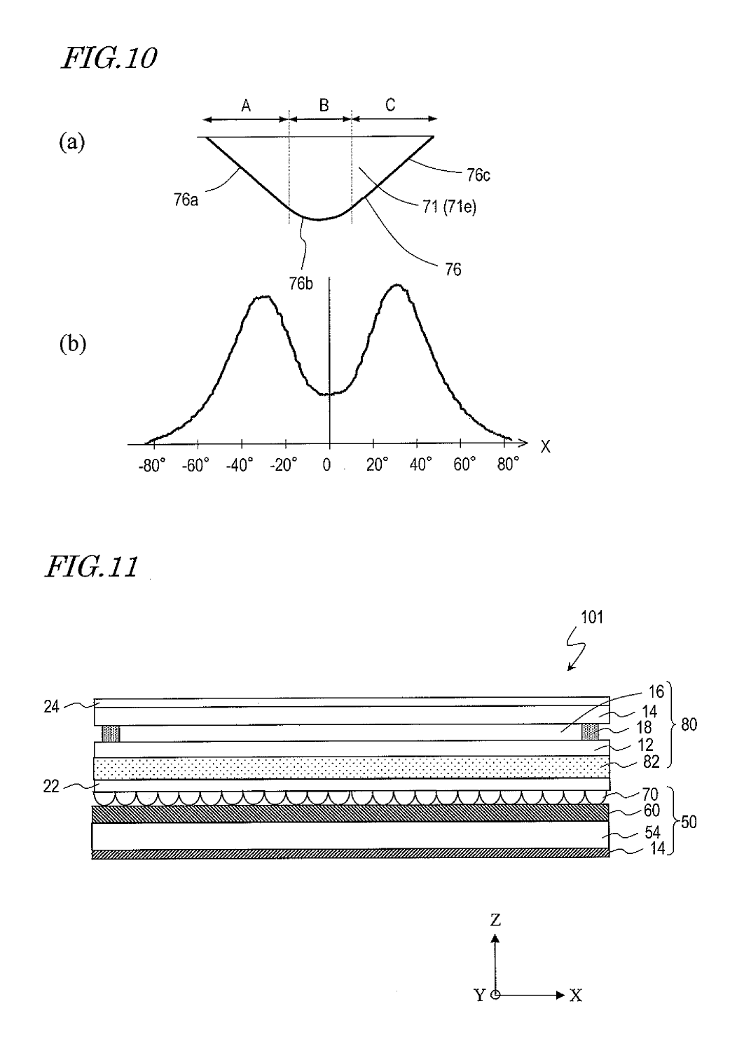

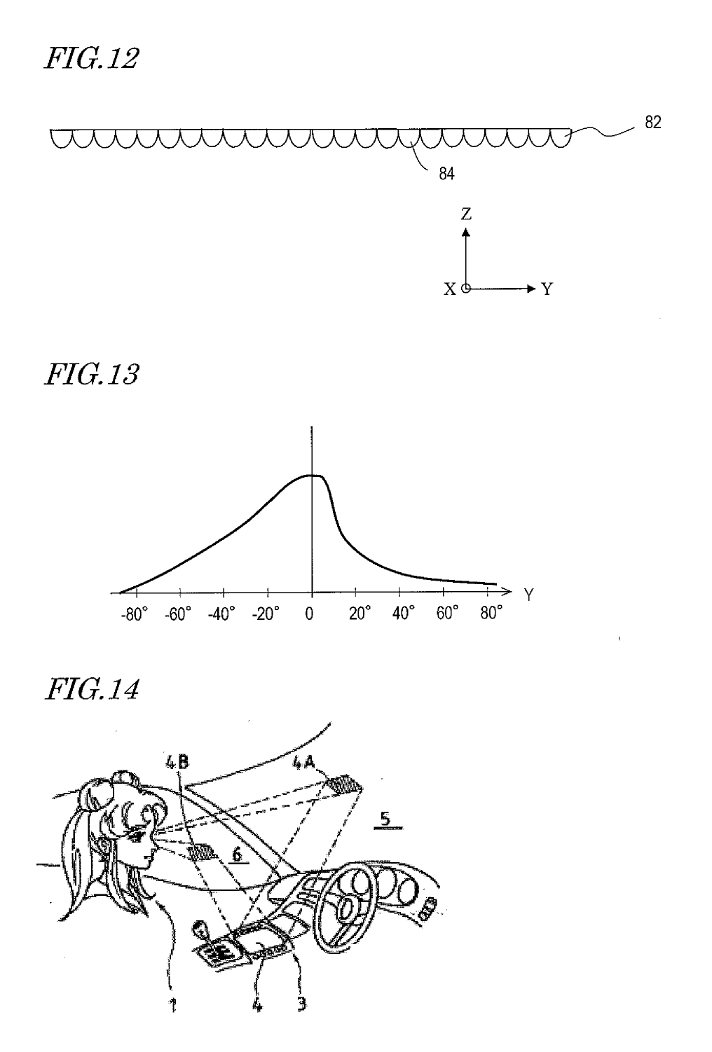

### BRIEF DESCRIPTION OF DRAWINGS

[FIG. 1] A cross-sectional view schematically showing the configuration of a liquid crystal display device 100 of Embodiment 1 of the present invention.

[FIG. 2] A perspective view schematically showing the configuration of the liquid crystal display device 100.

[FIG. 3] A cross-sectional view schematically showing the shape of an optical sheet 70 of the liquid crystal display device 100.

[FIG. 4] (a) is a cross-sectional view showing the shape of a lens 71 of an optical sheet 70. (b) is a graph showing the viewing angle characteristic along the X direction of the liquid crystal display device 100.

[FIG. 5] (a) a cross-sectional view showing the shape of a lens 71b of the first variation optical sheet 70. (b) shows the viewing angle characteristic along the X direction of the liquid crystal display device 100 in which the lens 71b is used.

[FIG. 6] A diagram for illustration of the shape of a light receiving surface 73 of the lens 71b.

[FIG. 7] (a) a cross-sectional view showing the shape of a lens 71c of the second variation optical sheet 70. (b) shows the viewing angle characteristic along the X direction of the liquid crystal display device 100 in which the lens 71c is used.

[FIG. 8] A diagram for illustration of the shape of a light receiving surface 74 of the lens 71c.

[FIG. 9] (a) a cross-sectional view showing the shape of a lens 71d of the third variation optical sheet 70. (b) shows the viewing angle characteristic along the X direction of the liquid crystal display device 100 in which the lens 71d is used.

[FIG. 10] (a) a cross-sectional view showing the shape of a lens 71e of the comparative example optical sheet 70. (b) shows the viewing angle characteristic along the X direction of the liquid crystal display device 100 in which the lens 71e is used.

[FIG. 11] A cross-sectional view schematically showing the configuration of a liquid crystal display device 101 of Embodiment 2 of the present invention.

[FIG. 12] A cross-sectional view schematically showing the shape of a microlens array 82 of the liquid crystal display device 101.

[FIG. 13] A graph which shows the viewing angle characteristic along the Y axis of the liquid crystal display device 101.

[FIG. 14] An illustration used in Patent Document 3 for describing problems in an onboard liquid crystal display.

[FIG. 15] A perspective view showing the configuration of a backlight disclosed in Patent Document 2.

[FIG. 16] (a) and (b) graphs schematically showing the viewing angle characteristics in the X direction and the Y direction of the backlight disclosed in Patent Document 2.

### DESCRIPTION OF EMBODIMENTS

Hereinafter, embodiments of the liquid crystal display device of the present invention are described with reference to the drawings.

### Embodiment 1

FIG. 1 is a cross-sectional view schematically showing the configuration of a liquid crystal display device 100 of Embodiment 1 of the present invention. FIG. 2 is a perspective view schematically showing the configuration of the liquid crystal display device 100. FIG. 3 is a cross-sectional view schematically showing the shape of an optical sheet 70 of the liquid crystal display device 100. The liquid crystal display device 100 is a liquid crystal display device which is suitable to onboard applications, although the uses thereof are not limited to onboard applications.

The liquid crystal display device 100 is an active matrix type transmissive liquid crystal display device (LCD). The liquid crystal display device 100 may be a transflective liquid crystal display device. The liquid crystal display device 100 has a plurality of pixels which are arranged in a matrix along the X direction (second direction) and the Y direction (first direction) which are perpendicular to each other in a substrate surface.

As shown in FIG. 1 and FIG. 2, the liquid crystal display device 100 includes a liquid crystal panel 10 and a backlight 50 which is provided at the lower side of the liquid crystal panel 10 (at a surface of the liquid crystal panel 10 which is opposite to the display surface). The liquid crystal panel 10 includes a TFT substrate 12 which has TFTs and pixel electrodes in respective pixels, a counter substrate 14 which is a color filter substrate (CF substrate) including a counter electrode which opposes the pixel electrodes, and a liquid crystal layer 16. The liquid crystal layer 16 includes a liquid crystal material encapsulated between the TFT substrate 12 and the counter substrate 14. The liquid crystal material is tightly sealed by a sealant 18 provided at the perimeter.

The upper surface (viewer side surface) of the liquid crystal panel 10 is provided with an optical film (front-face side optical film) 24, while the lower surface is provided with another optical film (rear-face side optical film) 22. The optical films 22 and 24 each include a polarizer (polarizing film). The two polarizers of the optical films 22 and 24 are in a crossed Nicols arrangement such that the transmission axes (or absorption axes) are perpendicular to each other. The optical films 22 and 24 may include other optical elements, such as a retarder, a light diffusing sheet, etc.

The backlight 50 includes a light source 52, such as an LED, a cathode ray tube, or the like, a light guide plate 54 for guiding light emitted from the light source 52, a reflector 56 placed under the light guide plate 54 (at a side of the light guide plate 54 which is opposite to the liquid crystal panel 10), a prism sheet 60 placed over the light emitting surface of the light guide plate 54 (at a side of the light guide plate 54 which is closer to the liquid crystal panel 10), and an optical sheet (optical element layer) 70 placed over the prism sheet 60. The lower part of the light guide plate 54, facing on the reflector 56, has sawtooth-like grooves, which constitute a prism array 58 that has a plurality of slope surfaces with different slope angles. Here, the plurality of slope surfaces of the prism array 58 are shaped such that the slope angle increases as the distance from the light source 52 increases.

The light emitted from the light source 52 is reflected by the reflector 56 or the slope surfaces of the prism array 58 and then passes through an upper surface (light emitting surface) of the light guide plate 54. The light is then refracted by prisms of the prism sheet 60 and lenses 71 of the optical sheet 70 and then emitted toward the liquid crystal panel 10.

Part of the light emitted from the light source 52 which is incident on the surfaces of the prism array 58 and the upper surface of the light guide plate 54 with an angle equal to or greater than the critical angle is totally reflected by these surfaces. On the other hand, another part of the light which is incident on the surfaces with an angle smaller than the critical angle is partially reflected while the remaining part is refracted and output from the bottom surface or the upper surface. The light output from the bottom surface is reflected by the reflector 56 to again enter the light guide plate 54, while the light output from the upper surface advances toward the prism sheet 60. With such a setup, light propagating in the light guide plate 54 is gradually emitted toward the prism sheet 60 while repeatedly undergoing reflection and refraction.

The prism sheet 60 includes a plurality of prisms, each extending in the X direction. When a cross section of the prism sheet 60 in a Y-Z plane is seen, each of the plurality of prisms has a vertex portion which is tapered toward the light guide plate 54 as shown in FIG. 1. The vertex angle of the vertex portion is desirably in the range of not less than 45° and not more than 75°. This arrangement enables providing light emission which has high directivity in the Z direction (the direction perpendicular to the substrate surface (X-Y plane)) such that the half-value width in the viewing angle characteristic is not more than 30° (±15°).

The optical sheet 70 includes a plurality of lenticular lenses 71, each extending in the Y direction as shown in FIG. 3. The lenticular lenses 71 are also simply referred to as “lenses 71”. When a cross section of the optical sheet 70 in an X-Z plane is seen, each of the plurality of lenses 71 has a light receiving surface protruding toward the light guide plate 54 as shown in FIG. 2 and FIG. 3.

Next, more detailed description of the lenses 71 (71a) of the optical sheet 70 is provided with reference to FIG. 4. FIG. 4(a) shows the cross-sectional shape of the lens 71a in an X-Z plane. FIG. 4(b) shows the viewing angle characteristic (the polar angle dependence of the luminance) for the X direction of the liquid crystal display device 100. The ordinate axis of FIG. 4(b) represents the luminance in display, and the abscissa axis represents the polar angle where the Z direction is 0°.

As shown in FIG. 4(a), the light receiving surface 72 of the lens 71a is formed by a curve surface whose curvature (and radius of curvature) is constant. In the present embodiment, the radius of curvature of the light receiving surface 72 is 24.5 μm. The radius of curvature of the light receiving surface 72 is preferably not less than 10 μm and not more than 200 μm. If the radius of curvature is less than 10 μm, variations in dimensions disadvantageously become large in the manufacture process. If the radius of curvature is more than 200 μm, the thickness of the device may become excessively large, and moiré fringes may be more likely to occur due to the relation with the pixel pitch. By using the optical sheet 70 which has the lenses 71a of such a shape, the viewing angle characteristic shown in FIG. 4(b), which has relatively small dependence on the direction of polar angle 0°, such as shown in FIG. 4(b), can be obtained.

As seen from the comparison with FIG. 16(a), using the optical sheet 70 enables achieving such characteristics that the luminance in the direction of polar angle 0° is less prominent than in a case where the prism sheet 205 is used and that the luminance is relatively uniform in the polar angle range of not less than −40° and not more than 40°. Therefore, when the liquid crystal display device 100 is installed in a vehicle as shown in FIG. 14 (where a traverse direction of the vehicle is the X direction), display with high light utilization efficiency is obtained such that the luminance for an undesired direction is decreased while sufficient luminance is provided in the directions toward the driver and the passenger in the passenger seat. As for the viewing angle characteristic for the Y direction, using the prism sheet 60 enables providing such a characteristic that the luminance in the direction of polar angle 0° is high while the luminance is extremely low in the polar angle range of not more than −30° and in the polar angle range of not less than 30°. Thus, reflection of images in the windshield can be prevented.

Next, variations of the optical sheet 70 which are applicable to Embodiment 1 are described with reference to FIG. 5 to FIG. 9.

FIG. 5(a) shows a cross-sectional shape of the lens 71 (71b) of the first variation optical sheet 70 in an X-Z plane. FIG. 5(b) shows the viewing angle characteristic for the X direction of the liquid crystal display device 100 which includes the first variation optical sheet 70. The ordinate axis of FIG. 5(b) represents the luminance, and the abscissa axis represents the polar angle where the Z direction is 0°. FIG. 6 is a diagram for illustration of the shape of a light receiving surface 73 of the lens 71b.

As shown in FIG. 5(a), the light receiving surface 73 of the lens 71b includes a curve surface 73b (first curve surface) protruding toward the backlight 50, and a curve surface 73a (second curve surface) and a curve surface 73c (third curve surface) between which the curve surface 73b extends. The curve surface 73a and the curve surface 73c are curve surfaces protruding in opposite directions to the protrusion of the curve surface 73b. The radius of curvature of the curve surface 73b is 24.5 μm. The radius of curvature of the curve surface 73a and the curve surface 73c is −24.5 μm. In this way, if the curvature of the curve surface 73b is positive, the curve surface 73a and 73c have a negative curvature. Supposing that the curve surfaces 73a, 73b and 73c are projected onto the substrate surface, the widths of these surfaces along the X direction, A, B and C, are 14 μm, 28 μm and 14 μm, respectively.

Circles a, b and c shown in FIG. 6 are osculating circles of the curve surfaces 73a, 73b and 73c, respectively. Either of these osculating circles has a radius of 24.5 μm. Cross sections of the curve surfaces 73a, 73b and 73c in an X-Z plane correspond to circumference portions of their osculating circles which correspond to the central angles of θ1=45°, θ2=90° and θ3=45°, respectively.

By using the optical sheet 70 which is composed of the lenses 71b having such a shape, a viewing angle characteristic is obtained as shown in FIG. 5(b) such that the luminance is relatively uniform in the polar angle range of not less than −30° and not more than 30° while the luminance is extremely low in the polar angle range of not more than −30° and in the polar angle range of not less than 30°. Therefore, when the liquid crystal display device 100 is installed in a vehicle, display with high light utilization efficiency is obtained such that the luminance for an undesired direction is decreased while sufficient luminance is provided in the directions toward the driver and the passenger in the passenger seat.

To make the liquid crystal display device more suitable to onboard applications, it is preferred that, for the viewing angle characteristic in the X direction, the luminance is relatively uniformly increased in the polar angle range of not less than −40° and not more than 40° while the luminance is sharply decreased in the polar angle range of not more than −40° and in the polar angle range of not less than 40°. With such an arrangement, extremely bright display can be provided to the driver and the passenger, while reflection of images in the side door's glass can be extremely decreased.

Such more preferable viewing angle characteristics can be obtained in the liquid crystal display device 100 including the second variation optical sheet 70 which is described below.

FIG. 7(a) shows a cross-sectional shape of the lens 71 (71c) of the second variation optical sheet 70 in an X-Z plane. FIG. 7(b) shows the viewing angle characteristic for the X direction of the liquid crystal display device 100 which includes the second variation optical sheet 70. The ordinate axis of FIG. 7(b) represents the luminance, and the abscissa axis represents the polar angle where the Z direction is 0°. FIG. 8 is a diagram for illustration of the shape of a light receiving surface 74 of the lens 71c.

As shown in FIG. 7(a), the light receiving surface 74 of the lens 71c includes a curve surface 74b (first curve surface) protruding toward the backlight 50, and a curve surface 74a (second curve surface) and a curve surface 74c (third curve surface) between which the curve surface 74b extends. The curve surface 74a and the curve surface 74c are curve surfaces protruding in opposite directions to the protrusion of the curve surface 74b. The radius of curvature of the curve surface 74b is 24.5 μm. The radius of curvature of the curve surface 74a and the curve surface 74c is −24.5 μm. In this way, if the curvature of the curve surface 74b is positive, the curve surface 74a and 74c have a negative curvature. Supposing that the curve surfaces 74a, 74b and 74c are projected onto the substrate surface, the widths of these surfaces along the X direction, A, B and C, are 5 μm, 35 μm and 5 μm, respectively.

Circles a, b and c shown in FIG. 8 are osculating circles of the curve surfaces 74a, 74b and 74c, respectively. Either of these osculating circles has a radius of 24.5 μm. Cross sections of the curve surfaces 74a, 74b and 74c in an X-Z plane correspond to circumference portions of their osculating circles which correspond to the central angles of θ1=15°, θ2=120° and θ3=15°, respectively. In this case, the half-value width of the luminance is ±42°.

By using the optical sheet 70 which is composed of the lenses 71c having such a shape, a viewing angle characteristic is obtained as shown in FIG. 7(b) such that the luminance is extremely uniformly high in the polar angle range of not less than −40° and not more than 40° while the luminance is extremely low in the polar angle range of not more than −40° and in the polar angle range of not less than 40°. Therefore, when the liquid crystal display device 100 is installed in a vehicle, display with high light utilization efficiency is obtained such that the luminance for an undesired direction is extremely decreased while sufficient luminance is provided in the directions toward the driver and the passenger in the passenger seat.

The radius of curvature of the curve surfaces 74a, 74b and 74c is preferably not less than 10 μm and not more than 200 μm. The ratio of the absolute value of each of the curvature of the curve surface 74a and the curvature of the curve surface 74c to the absolute value of the curvature of the curve surface 74b is preferably not less than 50% and not more than 150%. It is preferred that a cross section of the curve surface 74b in an X-Z plane is a circumference portion of the osculating circle of the curvature of the curve surface 74b which corresponds to a central angle of not less than 100° and not more than 140°. It is also preferred that cross-sections of the curve surface 74a and the curve surface 74c in an X-Z plane are circumference portions of the osculating circles of the curvature of the curve surface 74a and the curvature of the curve surface 74c which correspond to a central angle of not less than 10° and not more than 25°. By setting the curvature or central angle of the respective curve surfaces in such ranges, display with high light utilization efficiency is obtained such that the luminance is uniformly high in a desired range while the luminance is extremely low in an undesired range.

With the second variation optical sheet 70, light transmitted through the curve surfaces 74a and 74c is not allowed to outgo in undesired polar angle directions of ±60° to 90° but allowed to outgo in desired polar angle directions of ±30° to 40°. This arrangement enables providing a viewing angle characteristic shown in FIG. 7(b) such that the luminance is uniform and high in the range of −40° to +40°, while the luminance is extremely low in the other ranges.

For example, in the lens 71 shown in FIG. 4(a), light transmitted through both edge portions of the light receiving surface 72 (circular arc portions of the osculating circle corresponding to the central angle of about 30° from both edges) rarely travels in directions of polar angles of −40° to +40°. The second variation optical sheet 70 enables deflecting light transmitted through both edge portions of the lens to outgo in desired directions, so that more preferred viewing angle characteristics can be obtained. The light receiving surface consisting only of curve surfaces can be manufactured more easily than a light receiving surface which includes a flat surface. Also, such a light receiving surface is preferable because it can more readily control the viewing angle characteristics. When the light receiving surface includes a flat surface, violent changes, such as peaks and troughs, are likely to occur in the viewing angle characteristics. However, when the light receiving surface consists only of curve surfaces, such violent changes are unlikely to occur.

Next, a liquid crystal display device which includes a third variation optical sheet 70 is described.

FIG. 9(a) shows a cross-sectional shape of the lens 71 (71d) of the third variation optical sheet 70 in an X-Z plane. FIG. 9(b) shows the viewing angle characteristic for the X direction of the liquid crystal display device 100 which includes the third variation optical sheet 70. The ordinate axis of FIG. 9(b) represents the luminance, and the abscissa axis represents the polar angle where the Z direction is 0°.

As shown in FIG. 9(a), the light receiving surface 75 of the lens 71d includes a curve surface 75b protruding toward the backlight 50, and a flat surface 75a and a flat surface 75c between which the curve surface 75b extends. The radius of curvature of the curve surface 75b is 24.5 μm. The flat surface 75a and the flat surface 75c are inclined from an X-Y plane by 45°. Supposing that the flat surface 75a, curve surface 75b and flat surface 75c are projected onto the substrate surface, the widths of these surfaces along the X direction, A, B and C, are 5 μm, 28 μm and 5 μm, respectively. By using the optical sheet 70 which is composed of the lenses 71d having such a shape, the viewing angle characteristic shown in FIG. 9(b) can be obtained.

The third variation optical sheet 70 enables providing a viewing angle characteristic shown in FIG. 9(b) such that the luminance is relatively uniform and high in the polar angle range of not less than −40° and not more than 40° while the luminance is extremely low in the polar angle range of not more than −40° and in the polar angle range of not less than 40°. Therefore, when the liquid crystal display device 100 is installed in a vehicle, display with high light utilization efficiency is obtained such that the luminance for an undesired direction is extremely decreased while sufficient luminance is provided in the directions toward the driver and the passenger in the passenger seat. Even when the light receiving surface 75 of the lens 71d includes the flat surface 75a and the flat surface 75c as in the third variation, the ratio of each of width A and width B shown in FIG. 9(a) to the lens width (A+B+C) is about 10% to 15%, so that relatively preferred viewing angle characteristics can be obtained.

FIG. 10(a) shows a cross-sectional shape of the lens 71 (71e) of the comparative example optical sheet 70 in an X-Z plane. FIG. 10(b) shows the viewing angle characteristic for the X direction of the liquid crystal display device 100 which includes the comparative example optical sheet 70. The ordinate axis of FIG. 10(b) represents the luminance, and the abscissa axis represents the polar angle where the Z direction is 0°.

As shown in FIG. 10(a), the light receiving surface 76 of the lens 71e includes a curve surface 76b protruding toward the backlight 50, and a flat surface 76a and a flat surface 76c between which the curve surface 76b extends. The radius of curvature of the curve surface 76b is 8.5 μm. The flat surface 76a and the flat surface 76c are inclined from an X-Y plane by 45°. Supposing that the flat surface 76a, curve surface 76b and flat surface 76c are projected onto the substrate surface, the widths of these surfaces along the X direction, A, B and C, are 20 μm, 8.5 μm and 20 μm, respectively. By using the optical sheet 70 which is composed of the lenses 71e having such a shape, the viewing angle characteristic shown in FIG. 10(b) can be obtained.

When the comparative example optical sheet 70 is used in which the light receiving surface 76 of the lens 71e includes two relatively large surfaces between which the curve surface extends, light is excessively concentrated at specific polar angle positions (e.g., near polar angles of −30° and 30° in the comparative example), so that two peaks occurs in the viewing angle characteristic, and the luminance extremely decreases in the range between these peaks (near) 0°). Such concentration of light at specific polar angle positions is undesirable in terms of the viewing angle characteristics. Therefore, it is preferred that the light receiving surface of the lenses 71 of the optical sheet 70 does not include a large flat surface, as illustrated in the description of Embodiment 1 and its variations.

The liquid crystal display device 100 includes the optical sheet 70. Thus, when seen along the X direction, relatively uniform and high luminance display is provided in a specific polar angle range ranging around polar angle 0°, while display of extremely low luminance is provided in the other polar angle directions. Also, the intermediate luminance region ranging between the region in which high luminance display is provided and the region in which low luminance display is provided can be narrowed. Therefore, in an application which requires high luminance display only in a specific region, the requirement is fulfilled, while display with high light utilization efficiency can be provided with small light outgoing to undesired regions. Further, the viewing angle characteristic along the Y direction is appropriately adjusted by the prism sheet 60, and when seen along the Y direction, high luminance display is provided in a specific polar angle range ranging around polar angle 0°.

Therefore, when the liquid crystal display device 100 is installed in a vehicle, high quality display is provided to the driver and the passenger in the passenger seat, while reflection of images in the windshield and the side door's glass can be reduced.

The optical sheet 70 may be provided on a side of the prism sheet 60 which is closer to the light guide plate 54. The prism sheet 60 may be replaced by an optical sheet composed of a plurality of lenses extending in the X direction, each of which has the above-described shape of the lens 71. Alternatively, a prism sheet which is composed of such an optical sheet and a plurality of prisms extending in the Y direction may be used instead of the prism sheet 60 and the optical sheet 70.

Next, a liquid crystal display device of Embodiment 2 of the present invention is described. Note that, herein, the same components as those of Embodiment 1 are denoted by the same reference numerals, and the descriptions thereof are omitted.

### Embodiment 2

FIG. 11 is a cross-sectional view schematically showing the configuration of a liquid crystal display device 101 of Embodiment 2 of the present invention. FIG. 12 is a cross-sectional view schematically showing the shape of a microlens array 82 of the liquid crystal display device 101. FIG. 13 shows the viewing angle characteristic in the Y direction which is achieved by the liquid crystal display device 101. The ordinate axis of FIG. 13 represents the luminance, and the abscissa axis represents the polar angle where the Z direction is 0°.

The liquid crystal display device 101 is also an active matrix type transmissive or transflective liquid crystal display device which is suitable to onboard applications, as is the liquid crystal display device 100 of Embodiment 1. The liquid crystal display device 101 has a plurality of pixels which are arranged in a matrix along the X direction (second direction) and the Y direction (first direction) which are perpendicular to each other in a substrate surface.

As shown in FIG. 11, the liquid crystal display device 101 includes a liquid crystal panel 80 and a backlight 50 provided under the liquid crystal panel 80, which is the same as that used in Embodiment 1. The liquid crystal panel 80 includes a TFT substrate 12, a counter substrate 14, a liquid crystal layer 16, and a sealant 18, which are the same as those of Embodiment 1. The upper surface of the liquid crystal panel 80 is provided with an optical film 24, while the lower surface is provided with another optical film 22.

The liquid crystal panel 80 includes a microlens array 82 interposed between the TFT substrate 12 and the optical film 22. The microlens array 82 includes a plurality of microlenses 84 as shown in FIG. 12. Each of the microlenses 84 is a lenticular lens extending in the Y direction. The width of the lenticular lens along the X direction corresponds to the width of the pixels.

The microlens array 82 may be made of a photocurable resin. In the fabrication process of the liquid crystal panel 80, the photocurable resin is irradiated with light supplied through the openings of the pixels, whereby the microlenses 84 can be formed corresponding to the pixels in a self-aligning manner. The microlenses 84 can be formed by, for example, molding a resin with a stamper. The gap between the microlens array 82 and a protection layer may be filled with a material which has a refractive index different from that of the microlens array 82. With such a configuration adopted, the strength of the liquid crystal panel 80 can be increased.

Since the liquid crystal display device 101 includes the backlight 50 which is the same as that of Embodiment 1, display with high light utilization efficiency can be obtained such that the luminance is uniformly high in a desired range while the luminance is extremely low in an undesired range, which is basically the same as that obtained in the liquid crystal display device 100 of Embodiment 1. Note that, however, since the liquid crystal display device 101 further includes the microlens array 82, the viewing angle characteristic obtained is asymmetric in terms of the Y direction as shown in FIG. 13. Thus, when the liquid crystal display device 101 is installed in a vehicle, improved display can be provided in which, for example, reflection of images in the windshield on the driver's side can be extremely prevented.

The viewing angle characteristic shown in FIG. 13 is obtained by an asymmetric shape of each microlens 84, which is asymmetric along the Y direction. Even when the microlens array 82 is not used, light emitted from the backlight 50 may have some symmetric characteristic in the Y direction. However, it is difficult for the reversed prism of the prism sheet 60 to solely provide emitted light a desired viewing angle characteristic. In the liquid crystal display device of Embodiment 2, the microlens array 82 also contributes to control of the viewing angle characteristic, so that more preferable viewing angle characteristics can be obtained.

### INDUSTRIAL APPLICABILITY

The present invention is suitably applicable to liquid crystal display devices for television sets, personal computers, mobile devices, onboard devices, etc.

### REFERENCE SIGNS LIST

10, 80 liquid crystal panel

12 TFT substrate

14 counter substrate

16 liquid crystal layer

18 sealant

22 optical film (rear-face side optical film)

24 optical film (front-face side optical film)

50 backlight

52 light source

54 light guide plate

56 reflector

58 prism array

60 prism sheet

70 optical sheet (optical element layer)

71 lens

72, 73, 74, 75, 76 light receiving surface

82 microlens array

84 microlens

100, 101 liquid crystal display device

1. A liquid crystal display device having a plurality of pixels arranged in a matrix along a first direction and a second direction which are perpendicular to each other, comprising:
a TFT substrate including a plurality of pixel electrodes arranged so as to correspond to the plurality of pixels;
a counter substrate including a counter electrode which opposes to the pixel electrodes;
a liquid crystal layer interposed between the TFT substrate and the counter substrate;
an optical film including a polarizer provided on a surface of the TFT substrate which is opposite to the liquid crystal layer; and
a backlight provided on a side of the optical film which is opposite to the TFT substrate,
wherein the backlight includes a light guide plate for guiding light emitted from a light source and an optical element layer provided on a side of the light guide plate which is closer to the optical film, and
the optical element layer includes a plurality of lenticular lenses extending in the first direction, each of the lenticular lenses having a light receiving surface protruding toward the light guide plate.

2. The liquid crystal display device of claim 1, wherein
the backlight includes a prism sheet interposed between the light guide plate and the optical element layer, and
the prism sheet includes a plurality of prisms extending in the second direction, each of the prisms having a vertex portion tapered toward the light guide plate.

3. The liquid crystal display device of claim 1, wherein
the light receiving surface of each of the plurality of lenticular lenses includes a first curve surface protruding toward the backlight and a second curve surface and a third curve surface between which the first curve surface extends, and
if a curvature of the first curve surface is a positive curvature, each of the second and third curve surfaces has a negative curvature.

4. The liquid crystal display device of claim 3, wherein the light receiving surface does not include a flat surface but is composed of the first curve surface, the second curve surface and the third curve surface.

5. The liquid crystal display device of claim 3, wherein the second curve surface and the third curve surface have substantially equal curvatures.

6. The liquid crystal display device of claim 5, wherein the ratio of an absolute value of each of the curvature of the second curve surface and the curvature of the third curve surface to an absolute value of the curvature of the first curve surface is not less than 50% and not more than 150%.

7. The liquid crystal display device of claim 3, wherein
a cross section of the first curve surface in a plane which is perpendicular to the TFT substrate and which includes the second direction is a circumference portion of an osculating circle of the curvature of the first curve surface which corresponds to a central angle of not less than 100° and not more than 140°, and
a cross section of the second curve surface and a cross section of the third curve surface in a plane which is perpendicular to the TFT substrate and which includes the second direction are circumference portions of osculating circles of the curvature of the second curve surface and the curvature of the third curve surface which correspond to a central angle of not less than 10° and not more than 25°.

8. The liquid crystal display device of claim 1, further comprising a microlens array between the TFT substrate and the optical film, the microlens array having a plurality of microlenses extending in the second direction.

9. The liquid crystal display device of claim 1, wherein the liquid crystal display device is an onboard liquid crystal display device.

10. A backlight for supplying light for display to a liquid crystal display device, comprising:
a light guide plate for guiding light emitted from a light source; and
an optical element layer provided over a light emitting surface of the light guide plate,
wherein the optical element layer includes a plurality of lenticular lenses extending in a first direction, each of the lenticular lenses having a light receiving surface protruding toward the light guide plate.

11. The backlight of claim 10, further comprising a prism sheet interposed between the light guide plate and the optical element layer, the prism sheet including a plurality of prisms extending in a second direction that is perpendicular to the first direction, each of the prisms having a vertex portion tapered toward the light guide plate.

12. The backlight of claim 10, wherein
the light receiving surface of each of the plurality of lenticular lenses includes a first curve surface protruding toward the light guide plate and a second curve surface and a third curve surface between which the first curve surface extends, and
if a curvature of the first curve surface is a positive curvature, each of the second and third curve surfaces has a negative curvature.

13. The backlight of claim 12, wherein the light receiving surface does not include a flat surface but is composed of the first curve surface, the second curve surface and the third curve surface.

14. The backlight of claim 12, wherein the second curve surface and the third curve surface have substantially equal curvatures.

15. The backlight of claim 14, wherein the ratio of an absolute value of each of the curvature of the second curve surface and the curvature of the third curve surface to an absolute value of the curvature of the first curve surface is not less than 50% and not more than 150%.

16. The backlight of claim 12, wherein
a cross section of the first curve surface in a plane which is perpendicular to the light emitting surface of the light guide plate and which includes the second direction is a circumference portion of an osculating circle of the curvature of the first curve surface which corresponds to a central angle of not less than 100° and not more than 140°, and
a cross section of the second curve surface and a cross section of the third curve surface in a plane which is perpendicular to the light emitting surface and which includes the second direction are circumference portions of osculating circles of the curvature of the second curve surface and the curvature of the third curve surface which correspond to a central angle of not less than 10° and not more than 25°.
